(19) United States
(12) Patent Application Publication
(10) Pub. No.: US 2022/0023974 A1
(43) Pub. Date: Jan. 27, 2022

(54) PIPE PROCESSING MACHINE FOR CUTTING PIPES OR PROFILED SECTIONS USING A LASER BEAM

(71) Applicant: TRUMPF Werkzeugmaschinen GmbH + Co. KG, Ditzingen (DE)

(72) Inventors: Karsten Ruetz, Ludwigsburg (DE); Florian Jarsch, Ditzingen (DE); Philipp Matt, Schwieberdingen (DE)

(21) Appl. No.: 17/413,075

(22) PCT Filed: Nov. 11, 2019
(86) PCT No.: PCT/EP2019/080822

§ 371 Date: Jun. 11, 2021

(30) Foreign Application Priority Data
Dec. 11, 2018 (DE) 10 2018 131 781.6

(51) Int. Cl. B23K 26/38; B23K 26/08; B23K 37/02

(52) U.S. Cl. CPC B23K 26/38; B23K 37/0276; B23K 26/0876; B23K 26/0823

(57) ABSTRACT

A laser pipe cutting machine for cutting pipes or profiled sections using a laser beam generated by a laser unit, includes a machine bed on which a feed station is provided for feeding pipes or profiled sections to be processed along an x-axis, and a push-through chuck through which the pipe or profiled section is pushed to a cutting head. The cutting head is movably disposed along a y-axis running perpendicularly to the x-axis and along a z-axis running perpendicularly to the y-axis. The machine bed is equipped with an axis support on which the cutting head is movably mounted and the push-through chuck is disposed.

The invention relates to a pipe processing machine for cutting pipes or profiled sections by means of a laser beam, comprising a machine bed, on which a feed station is provided for feeding pipes or profiled sections to be processed along an X-axis. The pipe processing machine also has a push-through chuck, through which the pipe or profiled section is pushed to a cutting head. The cutting head is movably arranged along a Y-axis running perpendicular to the X-axis and which as a rule extends horizontally, and along a Z-axis running perpendicular to the Y-axis and which as a rule extends vertically.

Such a pipe processing machine is known, for example, from DE 10 2016 106 067 A1 or EP 2 017 023 B1. In such pipe processing machines, a processing station formed separately from the machine bed is provided, on which the cutting head is movably arranged along the Y-axis and the Z-axis. Consequently, the known machines have two subassemblies; firstly, the machine bed comprising the feed station and comprising the push-through chuck and, secondly, the processing station comprising the cutting head and the guides for guiding the cutting head along the axes. The separate formation has the advantage that the subassemblies can be produced and transported separately from one another. However, it has transpired in practice that the machine device is comparatively complicated, since the two subassemblies have to be aligned exactly with each other in order ultimately to ensure precise cutting of the pipe or profiled section. In addition, disadvantages with regard to the machine dynamics result, since an oscillation of the machine bed with respect to the largely stationary processing station can occur, which can result in processing inaccuracies.

The present invention is based on the object of providing a pipe processing machine of the type mentioned at the beginning which provides a remedy for the aforementioned disadvantages.

This object is achieved by a pipe processing machine having the features of patent claim 1.

According to the invention, provision is consequently made for an axis support, on which the cutting head is movably mounted and the push-through chuck is arranged, to be arranged on the machine bed. Because, firstly, the cutting head is movably provided on the axis support and, secondly, the push-through chuck is also arranged on the axis support, it is possible to implement a machine in which the individual functional components are permanently aligned exactly with one another. Complicated erection of the machine during its mounting is dispensed with. The axis support formed with the machine bed can then be fabricated with the machine bed in such a way that the result is exact positioning of the individual components relative to one another.

The machine bed can in particular be formed in one piece with the axis support, wherein the machine bed can be non-detachably connected to the axis support.

Advantageously, the machine bed and the axis support are joined by means of welding. In particular metal-removing machining of the machine bed together with axis support is carried out after the joining, preferably within a single setting. As a result, it is possible to ensure that the two components, the machine bed and the axis support, are machined jointly after the joining, so that an exact alignment is permanently maintained.

However, it is also conceivable that the machine bed and the axis support are joined to each other by screws.

In order to avoid possible torsion of the axis support about the X-axis, it is advantageous if the axis support has a greater extent than the machine bed in the Y direction, i.e. in the horizontal direction. This results in a larger standing surface and therefore a higher torsional rigidity, the result of which, overall, is a rugged construction of the machine.

Furthermore, it is advantageous if the push-through chuck is arranged fixedly on the axis support such that it is immovable in the direction of the X-axis. This also contributes to a permanent positionally accurate alignment of the parts. In addition, a higher accuracy during laser cutting can be achieved, since the tool center point (TCP) then has a constant distance from the push-through chuck during the processing. The distance can be comparatively small, so that disruptive oscillations on the machine and/or on the pipe or profiled section to be processed can be minimized. Since the cutting head and the push-through chuck are implemented in the same subassembly, undesired oscillations between the pipe or profiled section guided by the push-through chuck and the cutting head can largely be suppressed.

In a further embodiment of the invention, provision is made for a Y-guide with a slide that can be moved along the Y-guide to be provided on the axis support for the mobility of the cutting head along the Y-axis. Furthermore, a Z-guide with a slide that can be moved along the Z-guide is provided on the Y-slide for the mobility of the cutting head along the Z-axis. The cutting head is then arranged on the Z-slide. With the arrangement described, the cutting head can be moved in a relatively simple manner along the Y-axis and, independently thereof, along the Z-axis.

In another embodiment of the invention, provision is made for the cutting head to be movable along an additional X-axis. As a result of this formation, the cutting head can additionally be moved along the additional X-axis, which produces a greater clearance between the cutting head and the push-through chuck. Despite a stationary push-through chuck, this permits the cutting of long contours and reduces a risk of collision.

According to the invention, provision can also be made for the axis support to have a Y-guide with a Y-slide that can be moved along the Y-guide for the mobility of the cutting head along the Y-axis, and for an additional X-guide with an additional X-slide that can be moved along the additional X-guide to be provided on the Y-slide for the mobility of the cutting head along the additional X-axis. In this formation, a Z-guide with a Z-slide that can be moved along the Z-guide is then provided on the additional X-slide for the mobility of the cutting head along the Z-axis, wherein the cutting head is then arranged on the Z-slide.

Preferably, provision is further made for the cutting head to be arranged such that it can be pivoted about the Y-axis along a B-axis. Then, if the cutting head is provided on the Z-slide, a pivoting guide for pivoting the cutting head about the Y-axis along a B-axis can consequently be provided on the Z-slide.

In the more remote position of the cutting head from the push-through chuck, the cutting head can be pivoted about the B-axis relative to the push-through chuck or away from the latter, without colliding with the push-through chuck. In this way, in particular oblique cuts, i.e. laser cuts which are not perpendicular to the pipe surface, can be implemented.

In current pipe cutting machines, for the oblique cut the push-through chuck is moved away from the cutting head along the X direction in order to permit the rotation of the cutting head. The B-axis remains stationary in the X direction. During the rotation of the cutting head, different distances are produced between TCP and push-through chuck. This leads to accuracy losses.

In one embodiment according to the invention with an additional X-axis, the latter can be used to keep the TCP always at a constant distance from the push-through chuck during the cutting step, in that the additional X-axis carries out compensating movements relative to the B-axis. This brings advantages in the accuracy of the oblique-cut processing.

In a further embodiment, the additional X-axis can also be implemented as a highly dynamic axis and be superimposed on the X-axis. As a result, productivity advantages can be produced during the fabrication of small contours, since the additional X-axis can be designed to be substantially more dynamic than the X-axis moving the pipe.

In an alternative embodiment, instead of the above-described order of the axes, Y-axis, additional X-axis, Z-axis, B-axis, the following axis sequences can also be provided:

additional X-axis, Y-axis, Z-axis, B-axis; or

Y-axis, Z-axis, additional X-axis, B-axis.

Since the machine bed is permanently arranged positionally accurately with the axis support, it is advantageous if interfaces for the arrangement of further functional components are provided on the axis support. Such components can be, in particular, cameras, sensors, device plates, protective hoods, operating panels, seam position detection devices and/or seam position control devices.

Further advantageous refinements and details of the invention can be gathered from the following description, on the basis of which two embodiments of the invention are described in detail and explained.

In the figures:

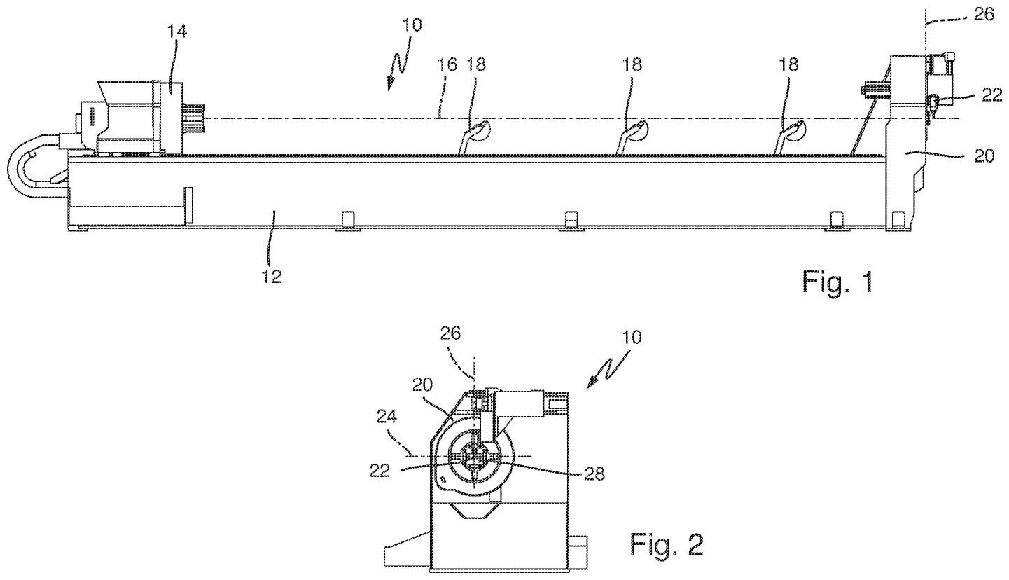

FIG. 1 shows a pipe processing machine according to the invention in side view;

FIG. 2 shows the machine according to FIG. 1 in front view;

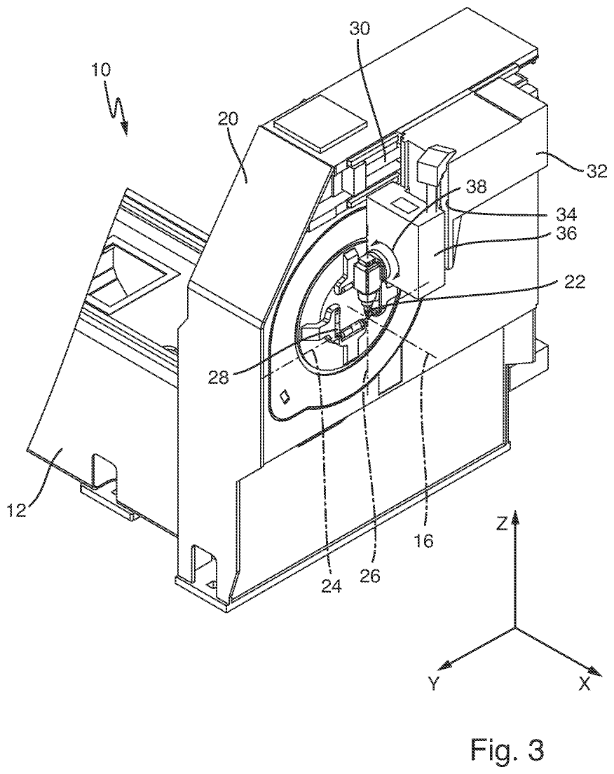

FIG. 3 shows a detail of the machine according to FIG. 1 in an isometric view;

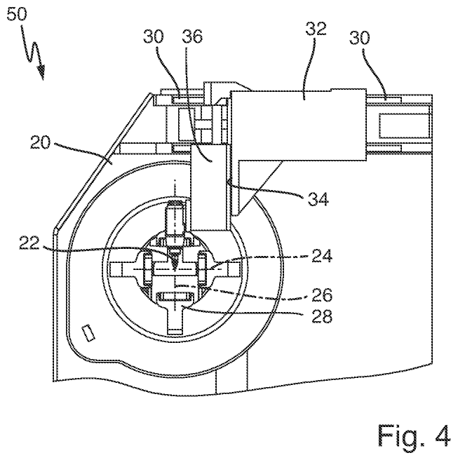

FIG. 4 shows the front view of a second machine according to the invention; and

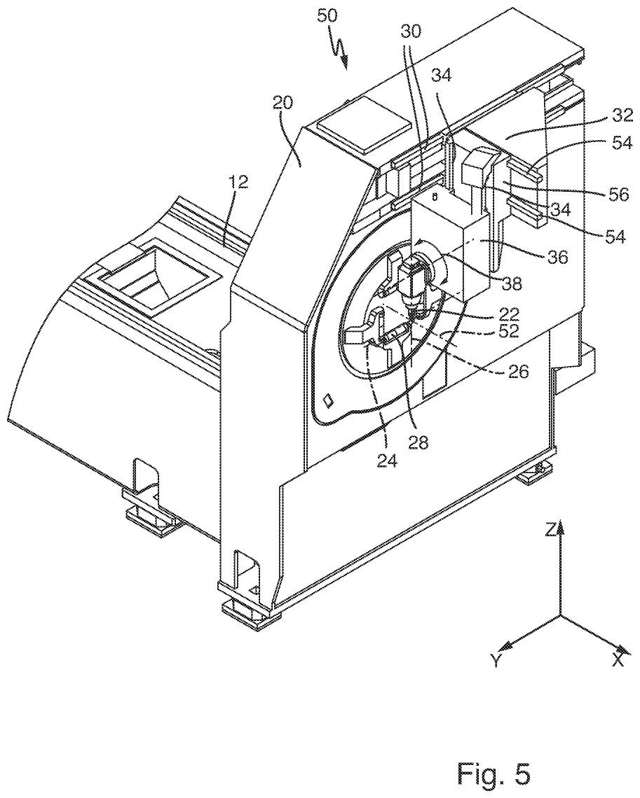

FIG. 5 shows a detail of the machine according to FIG. 4 in an isometric view.

In FIGS. 1 to 3, a pipe processing machine 10 for cutting pipes or profiled sections by means of a laser beam is shown. The machine 10 comprises a machine bed 12, on which a feed station 14 is provided for feeding pipes or profiled sections to be processed along an X-axis 16. For the support of pipes or profiled sections, not illustrated in the figures, workpiece supports 18 are provided on the machine bed 12.

On the front side of the machine 10, at the free end of the machine bed 12, an axis support 20 is provided, which is connected to the machine bed 12 in one piece and in particular non-detachably. Preferably, the axis support 20 is welded onto the machine bed 12. Processing of the machine bed 12 and of the axis support 20 is preferably carried out following the joining of the machine bed 12 and axis support 20. In this way, a permanent and positionally accurate arrangement of the components and the functional sections thereof relative to one another can be achieved.

However, according to the invention it is also conceivable that the machine bed and the axis support are detachably joined to each other, for example by screwing.

Provided on the axis support 20 is a cutting head 22, which is movably arranged along a Y-axis 24 running perpendicular to the X-axis 16 and in the horizontal direction, and a Z-axis 26 running perpendicular to the X-axis in the vertical direction. The axis support 20 also has a push-through chuck 28, through which the pipe or profiled section to be processed is guided by the axis support 20 and by means of which the pipe or profiled section can be clamped during the processing. The push-through chuck 28 is arranged to be fixed in the direction of the X-axis and immovably on the axis support 20.

To provide a laser beam emerging from the cutting head 22, by means of which the pipe or profiled section to be processed is cut, a laser generator, not illustrated in the figures, is provided, the laser beam generated by which is deflected toward the cutting edge 22 by deflection means, likewise not illustrated in detail.

As becomes clear in particular from FIG. 3, the axis support 20 has a greater extent in the direction of the Y-axis 24 than the machine bed 12. This results in a stable and rugged arrangement. In particular, torsion about the X-axis 16 can reliably be suppressed.

As further becomes clear, in particular from FIG. 3, a Y-guide 30 is provided on the axis support, in which a Y-slide 32 can be moved in the direction of the Y-axis 24. The Y-slide 32 provides a Z-guide 34, along which a Z-slide 36 is movably arranged. Finally, the cutting head 22 is arranged on the Z-slide 36, wherein the cutting head can be rotated about the Y-axis 24 along a B-axis, which is indicated by the arrow 38.

The control of the cutting head 22 along the Y-axis 24, the Z-axis 26 and the B-axis 38 is carried out via a machine controller, which controls appropriately arranged and set-up drive units for displacing the cutting head 22. The machine controller can be provided in a switch cabinet, which is formed in one piece with the machine bed 12 and in particular is non-detachably connected to the machine bed 12. The switch cabinet can in particular be welded onto the machine bed 12.

In FIGS. 4 and 5, a further pipe processing machine 50 according to the invention is shown, the structure of which corresponds substantially to the structure of the pipe processing machine 10. Corresponding components are provided with corresponding designations.

As distinct from the pipe processing machine 10, in the pipe processing machine 50 the cutting head 22 is additionally movable along an additional X-axis 52. To this end, an additional X-guide 54, along which an additional X-slide 56 can be moved, is provided on the Y-slide 32. The slide 56 then has the Z-guide 34, along which the Z-slide 36 can be moved. In a way corresponding to the pipe processing machine 10, in the pipe processing machine 50 the cutting head on the Z-slide 36 can also be pivoted about the Y-axis 24 along the B-axis 38.

In the machine 50, as in the machine 10, CNC-controlled drives are provided, with which the cutting head 22 can ultimately be moved along the Y-axis 24, the Z-axis 26, the additional X-axis 52 and the B-axis 38.

1-14. (canceled)

15. A pipe processing machine for cutting pipes or profiled sections using a laser beam, the pipe processing machine comprising:
a machine bed;
an axis support disposed on said machine bed;
a feed station provided on said machine bed for feeding pipes or profiled sections to be processed along an X-axis;
a cutting head movably mounted on said axis support, said cutting head being movable along a Y-axis running perpendicular to the X-axis and along a Z-axis running perpendicular to the Y-axis; and
a push-through chuck through which the pipe or profiled section is to be pushed to said cutting head, said push-through chuck being disposed on said axis support.

16. The pipe processing machine according to claim 15, wherein said machine bed is formed in one piece with said axis support.

17. The pipe processing machine according to claim 15, wherein said machine bed is non-detachably connected to said axis support.

18. The pipe processing machine according to claim 15, wherein said machine bed and said axis support are joined together by welding or by screws.

19. The pipe processing machine according to claim 15, wherein said axis support has a greater extent than said machine bed in the Y direction.

20. The pipe processing machine according to claim 15, wherein said push-through chuck is disposed on said axis support immovably in direction of the X-axis.

21. The pipe processing machine according to claim 15, which further comprises:
a Y-guide disposed on said axis support, said Y-guide having a Y-slide movable along said Y-guide for moving said cutting head along the Y-axis;
a Z-guide provided on said Y-slide, said Z-guide having a Z-slide movable along the Z-guide for moving said cutting head along the Z-axis; and
said cutting head being disposed on said Z-slide.

22. The pipe processing machine according to claim 15, wherein said cutting head is movable along an additional X-axis.

23. The pipe processing machine according to claim 22, wherein the additional X-axis is aligned to hold said cutting head or a tool center point at a constant distance from said push-through chuck during an oblique cut.

24. The pipe processing machine according to claim 22, wherein the additional X-axis is a dynamic axis for superimposing movement with the X-axis.

25. The pipe processing machine according to claim 22, wherein:
said axis support has a Y-guide with a Y-slide movable along said Y-guide for moving said cutting head along the Y-axis;
an additional X guide is provided on said Y slide, said additional X guide has an additional X slide movable along said additional X guide for moving said cutting head along the additional x-axis;
a Z-guide is provided on said additional X-slide, said Z-guide has a Z-slide movable along said Z-guide for moving said cutting head along the Z-axis; and
said cutting head is disposed on said Z-slide.

26. The pipe processing machine according to claim 15, wherein said cutting head is pivotable about the Y axis.

27. The pipe processing machine according to claim 15, wherein said axis support has interfaces for an arrangement of further functional components.

28. The pipe processing machine according to claim 15, which further comprises a switch cabinet formed in one piece with said machine bed.
